(19) United States
(12) Patent Application Publication
(10) Pub. No.: US 2025/0133037 A1
(43) Pub. Date: Apr. 24, 2025

(54) GUIDED CONVERSATION CONTEXT COMPRESSION WITH ADVERSARIAL HYPOTHETICAL QUESTIONS AND EVALUATING RELEVANCE OF CONTEXTUAL INFORMATION FOR LLMS

(71) Applicant: Maplebear Inc., San Francisco, CA (US)

(72) Inventors: Jacob Jensen, Metuchen, NJ (US); Shubhanshu Mishra, Woodridge, IL (US); Aomin Wu, Scarsdale, NY (US); Rajpal Paryani, Fremont, CA (US); Guanghua Shu, Sunnyvale, CA (US); Sicheng Zhou, Jersey City, NJ (US)

(21) Appl. No.: 18/920,765

(22) Filed: Oct. 18, 2024

Related U.S. Application Data
(60) Provisional application No. 63/591,757, filed on Oct. 19, 2023.
(60) Provisional application No. 63/597,960, filed on Nov. 10, 2023.

(51) Int. Cl. H04L 51/02

(52) U.S. Cl. CPC H04L 51/02

(57) ABSTRACT

A system may smartly edit the context of a conversation to be input into a chatbot LLM by using a conversation compression algorithm to prune and compress redundant elements. The system evaluates the conversation context compression algorithm using both a chatbot LLM and an adversarial LLM. The system retrieves a logged conversation and generates a compressed conversation context from the logged conversation. The system generates a synthetic user response by applying the adversarial LLM and generates a test conversation by replacing a user response in the conversation with the synthetic user response. The system generates a compressed context of the test conversation. The system generates a test chatbot LLM response by prompting the chatbot LLM with the compressed context of the test conversation. The system evaluates the conversation context compression algorithm by comparing the test chatbot response with a benchmark chatbot response.

### CROSS-REFERENCE TO RELATED APPLICATIONS

This application claims the benefit of U.S. Provisional Patent Application No. 63/591,757, filed on Oct. 19, 2023, and U.S. Provisional patent Application No. 63/597,960,filed on Nov. 10, 2023, all of which are incorporated by reference herein in their entirety.

### BACKGROUND

Large language models (LLMs) have limited memory and passing large amounts of data to an LLM as input can be both computationally expensive and time consuming. To work around this issue, entities may be forced to discard data before inputting the data into an LLM. Though advantageous for reducing latency and cost of running an LLM, this workaround limits the usefulness of LLMs for long-duration tasks and often requires storage of additional data paired with complex data retrieval schemes. The online system may also maintain components of contextual information for the user, but each component of contextual information may vary in its relevance to accurately predicting the user's response.

### SUMMARY

In accordance with one or more aspects of the disclosure, a system may edit the context of a conversation to be input into a chatbot LLM by using a conversation compression algorithm to prune and compress redundant elements. To evaluate the compression algorithm, the system may retrieve logged conversations between a user and the chatbot LLM where the system had prompted the chatbot LLM with the full context of the conversation. The system may compare one or more chatbot LLM responses in a logged conversation to one or more chatbot LLM responses in a version of the logged conversation that the system alters in two ways. For the first alteration, the system prompts the chatbot LLM with the compressed context of the conversation. For the second alteration, the system replaces one or more user responses with synthetic user responses meant to simulate a confusing or uninformative response from a user in the conversation. To generate the synthetic user response, the system uses an adversarial LLM with an adversarial objective of causing the chatbot LLM, given a conversation that includes the substituted synthetic user response, to produce a low-quality response.

In one or more embodiments, the system evaluates a conversation context compression algorithm using both the chatbot LLM and adversarial LLM. The system retrieves a logged conversation from a data store and generates a compressed conversation context from the logged conversation. The system generates a synthetic user response by applying the adversarial LLM and generates a test conversation by replacing a user response in the conversation with the synthetic user response. The system generates a compressed context of the test conversation. The system generates a test chatbot LLM response by prompting the chatbot LLM with the compressed context of the test conversation. The system evaluates the conversation context compression algorithm by comparing the test chatbot response with a benchmark chatbot response.

In accordance with one or more aspects of the disclosure, an online system generates a predicted user response in conjunction with the model serving system or the interface system based on a request for the user to interact with the online system. An online system receives a request for a user to interact with the online platform. The online system generates a prompt for input to a machine-learned language model specifying at least a transcript of historical communications with the user, a context for the user's response, and a task request for a machine-learning language model to generate a prediction of the user's response. The context for the user's response may be made of individual contextual components with varying relevance to the prediction of the user's response.

The online system provides the prompt to a model serving system for execution by the machine-learning language model (e.g., LLM) for execution. The machine-learning language model predicts a user response to a previous request from the transcript of historical communications based on one or more contextual components. The machine-learning language model determines a perplexity score for each prediction based on a comparison of the prediction to the user's actual response such that the perplexity score characterizes the accuracy of a prediction generated based on each contextual component. The online system receives a perplexity score for the context generated by executing the machine-learning language model. The online system compares each perplexity score to a threshold perplexity to identify contextual components relevant to predicting the user's response to the prompt and stores the identified contextual components with a label describing the context surrounding the response from the user.

### BRIEF DESCRIPTION OF THE DRAWINGS

FIG. 1A illustrates an example system environment for an online system, in accordance with one or more embodiments.

FIG. 1B illustrates an example system environment for an online system, in accordance with one or more embodiments.

FIG. 2 illustrates an example system architecture for an online system, in accordance with one or more embodiments.

FIG. 3 depicts different strategies for conversational context compression, in accordance with one or more embodiments.

FIGS. 4A-4B is a flowchart for a method of evaluating compression policies for a chatbot application, in accordance with one or more embodiments.

FIG. 5 is a flowchart for a method of determining the relevance of contextual components for a machine-learning language model, in accordance with some embodiments.

### DETAILED DESCRIPTION

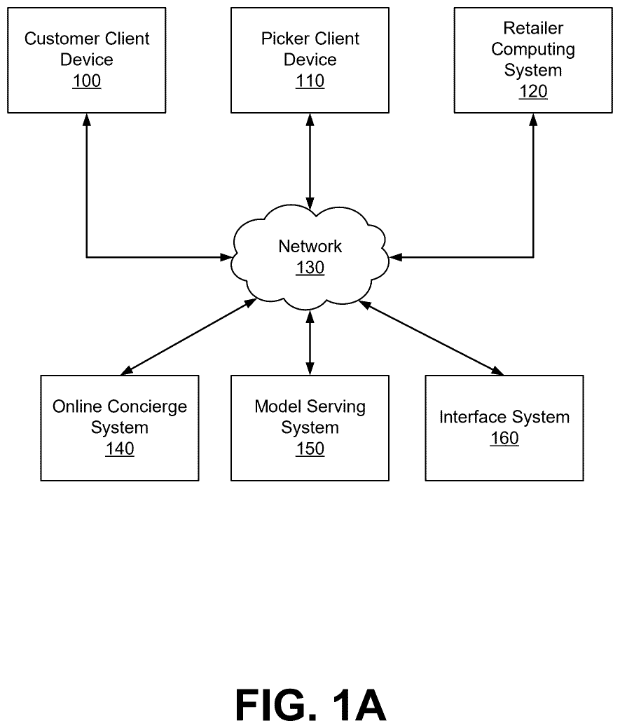

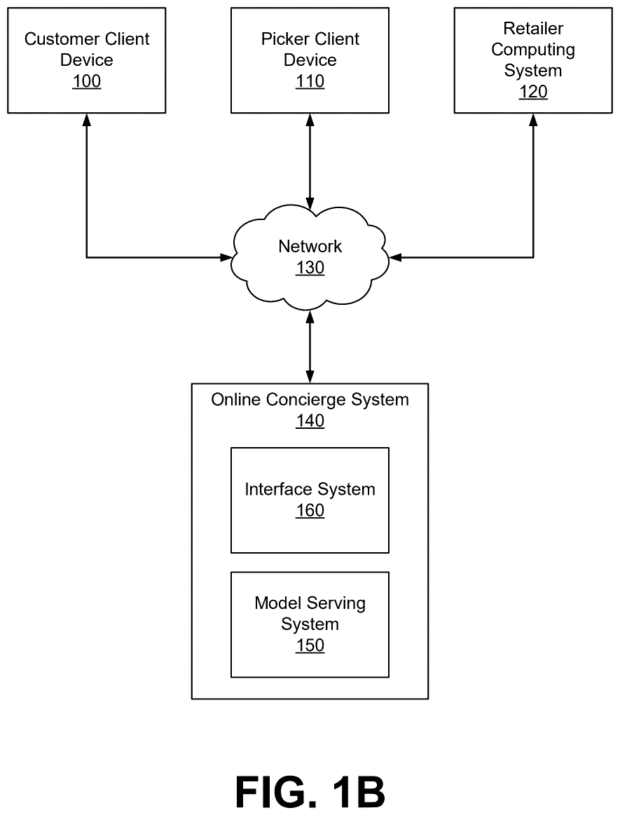

FIG. 1A illustrates an example system environment for an online system 140, in accordance with one or more embodiments. The system environment illustrated in FIG. 1A includes a customer client device 100, a picker client device 110, a retailer computing system 120, a network 130, and an online system 140. Alternative embodiments may include more, fewer, or different components from those illustrated in FIG. 1A, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online system 140. Additionally, while one customer client device 100, picker client device 110, and retailer computing system 120 are illustrated in FIG. 1, any number of customers, pickers, and retailers may interact with the online system 140. As such, there may be more than one customer client device 100, picker client device 110, or retailer computing system 120.

The customer client device 100 is a client device through which a customer may interact with the picker client device 110, the retailer computing system 120, or the online system 140. The customer client device 100 can be a personal or mobile computing device, such as a smartphone, a tablet, a laptop computer, or desktop computer. In one or more embodiments, the customer client device 100 executes a client application that uses an application programming interface (API) to communicate with the online system 140.

A customer uses the customer client device 100 to place an order with the online system 140. An order specifies a set of items to be delivered to the customer. An “item”, as used herein, means a good or product that can be provided to the customer through the online system 140. The order may include item identifiers (e.g., a stock keeping unit or a price look-up code) for items to be delivered to the user and may include quantities of the items to be delivered. Additionally, an order may further include a delivery location to which the ordered items are to be delivered and a timeframe during which the items should be delivered. In one or more embodiments, the order also specifies one or more retailers from which the ordered items should be collected.

The customer client device 100 presents an ordering interface to the customer. The ordering interface is a user interface that the customer can use to place an order with the online system 140. The ordering interface may be part of a client application operating on the customer client device 100. The ordering interface allows the customer to search for items that are available through the online system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the item should be collected.

The customer client device 100 may receive additional content from the online system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In one or more embodiments, messages sent between the customer client device 100 and the picker client device 110 are transmitted through the online system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online system 140. The picker client device 110 can be a personal or mobile computing device, such as a smartphone, a tablet, a laptop computer, or desktop computer. In one or more embodiments, the picker client device 110 executes a client application that uses an application programming interface (API) to communicate with the online system 140.

The picker client device 110 receives orders from the online system 140 for the picker to service. A picker services an order by collecting the items listed in the order from a retailer. The picker client device 110 presents the items that are included in the customer's order to the picker in a collection interface. The collection interface is a user interface that provides information to the picker on which items to collect for a customer's order and the quantities of the items. In one or more embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In one or more embodiments, the picker client device 110 transmits to the online system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In one or more embodiments, rather than or in addition to using a barcode scanner, the picker client device 110 captures one or more images of the item and determines the item identifier for the item based on the images. The picker client device 110 may determine the item identifier directly or by transmitting the images to the online system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In one or more embodiments, the picker client device 110 tracks the location of the picker as the picker delivers orders to delivery locations. The picker client device 110 collects location data and transmits the location data to the online system 140. The online system 140 may transmit the location data to the customer client device 100 for display to the customer such that the customer can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online system 140.

Additionally, while the description herein may primarily refer to pickers as humans, in one or more embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online system 140. As used herein, a “retailer” is an entity that operates a “retailer location,” which is a store, warehouse, or other building from which a picker can collect items. The retailer computing system 120 stores and provides item data to the online system 140 and may regularly update the online system 140 with updated item data. For example, the retailer computing system 120 provides item data indicating which items are available at a retailer location and the quantities of those items. Additionally, the retailer computing system 120 may transmit updated item data to the online system 140 when an item is no longer available at the retailer location. Additionally, the retailer computing system 120 may provide the online system 140 with updated item prices, sales, or availabilities. Additionally, the retailer computing system 120 may receive payment information from the online system 140 for orders serviced by the online system 140. Alternatively, the retailer computing system 120 may provide payment to the online system 140 for some portion of the overall cost of a user's order (e.g., as a commission).

The customer client device 100, the picker client device 110, the retailer computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In one or more embodiments, the network 130 may include Bluetooth or near-field communication (NFC) technologies or protocols for local communications between computing devices. The network 130 may transmit encrypted or unencrypted data.

The online system 140 is an online system by which customers can order items to be provided to them by a picker from a retailer. The online system 140 receives orders from a customer client device 100 through the network 130. The online system 140 selects a picker to service the customer's order and transmits the order to a picker client device 110 associated with the picker. The picker collects the ordered items from a retailer location and delivers the ordered items to the customer. The online system 140 may charge a customer for the order and provides portions of the payment from the customer to the picker and the retailer.

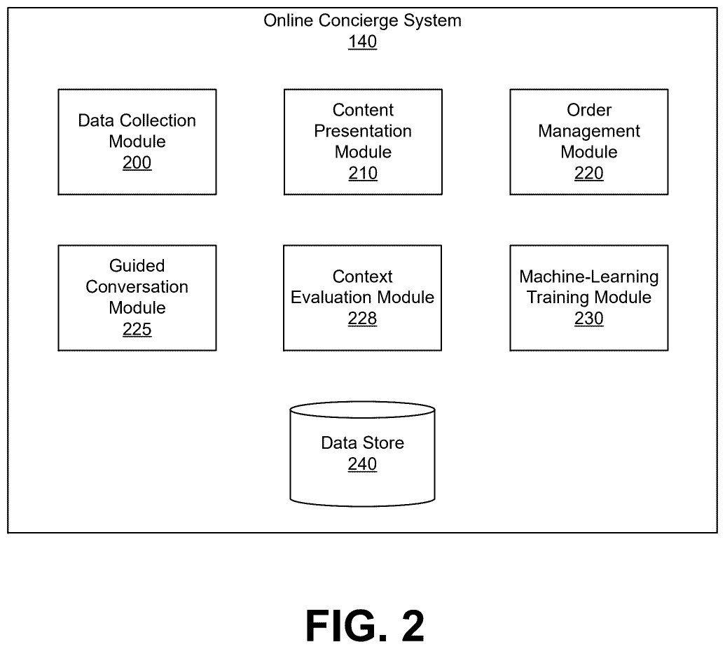

As an example, the online system 140 may allow a customer to order groceries from a grocery store retailer. The customer's order may specify which groceries they want delivered from the grocery store and the quantities of each of the groceries. The customer's client device 100 transmits the customer's order to the online system 140 and the online system 140 selects a picker to travel to the grocery store retailer location to collect the groceries ordered by the customer. Once the picker has collected the groceries ordered by the customer, the picker delivers the groceries to a location transmitted to the picker client device 110 by the online system 140. The online system 140 is described in further detail below with regards to FIG. 2.

The model serving system 150 receives requests from the online system 140 to perform tasks using machine-learned models. The tasks include, but are not limited to, natural language processing (NLP) tasks, audio processing tasks, image processing tasks, video processing tasks, and the like. In one or more embodiments, the machine-learned models deployed by the model serving system 150 are models configured to perform one or more NLP tasks. The NLP tasks include, but are not limited to, text generation, query processing, machine translation, chatbots, and the like. In one or more embodiments, the language model is configured as a transformer neural network architecture. Specifically, the transformer model is coupled to receive sequential data tokenized into a sequence of input tokens and generates a sequence of output tokens depending on the task to be performed.

The model serving system 150 receives a request including input data (e.g., text data, audio data, image data, or video data) and encodes the input data into a set of input tokens. The model serving system 150 applies the machine-learned model to generate a set of output tokens. Each token in the set of input tokens or the set of output tokens may correspond to a text unit. For example, a token may correspond to a word, a punctuation symbol, a space, a phrase, a paragraph, and the like. For an example query processing task, the language model may receive a sequence of input tokens that represent a query and generate a sequence of output tokens that represent a response to the query. For a translation task, the transformer model may receive a sequence of input tokens that represent a paragraph in German and generate a sequence of output tokens that represents a translation of the paragraph or sentence in English. For a text generation task, the transformer model may receive a prompt and continue the conversation or expand on the given prompt in human-like text.

When the machine-learned model is a language model, the sequence of input tokens or output tokens are arranged as a tensor with one or more dimensions, for example, one dimension, two dimensions, or three dimensions. For example, one dimension of the tensor may represent the number of tokens (e.g., length of a sentence), one dimension of the tensor may represent a sample number in a batch of input data that is processed together, and one dimension of the tensor may represent a space in an embedding space. However, it is appreciated that in other embodiments, the input data or the output data may be configured as any number of appropriate dimensions depending on whether the data is in the form of image data, video data, audio data, and the like. For example, for three-dimensional image data, the input data may be a series of pixel values arranged along a first dimension and a second dimension, and further arranged along a third dimension corresponding to RGB channels of the pixels.

In one or more embodiments, the language models are large language models (LLMs) that are trained on a large corpus of training data to generate outputs for the NLP tasks. An LLM may be trained on massive amounts of text data, often involving billions of words or text units. The large amount of training data from various data sources allows the LLM to generate outputs for many tasks. An LLM may have a significant number of parameters in a deep neural network (e.g., transformer architecture), for example, at least 1 billion, at least 15 billion, at least 135 billion, at least 175 billion, at least 500 billion, at least 1 trillion, at least 1.5 trillion parameters.

Since an LLM has significant parameter size and the amount of computational power for inference or training the LLM is high, the LLM may be deployed on an infrastructure configured with, for example, supercomputers that provide enhanced computing capability (e.g., graphic processor units) for training or deploying deep neural network models. In one instance, the LLM may be trained and deployed or hosted on a cloud infrastructure service. The LLM may be pre-trained by the online system 140 or one or more entities different from the online system 140. An LLM may be trained on a large amount of data from various data sources. For example, the data sources include websites, articles, posts on the web, and the like. From this massive amount of data coupled with the computing power of LLM's, the LLM is able to perform various tasks and synthesize and formulate output responses based on information extracted from the training data.

In one or more embodiments, when the machine-learned model including the LLM is a transformer-based architecture, the transformer has a generative pre-training (GPT) architecture including a set of decoders that each perform one or more operations to input data to the respective decoder. A decoder may include an attention operation that generates keys, queries, and values from the input data to the decoder to generate an attention output. In another embodiment, the transformer architecture may have an encoder-decoder architecture and includes a set of encoders coupled to a set of decoders. An encoder or decoder may include one or more attention operations.

While a LLM with a transformer-based architecture is described as a primary embodiment, it is appreciated that in other embodiments, the language model can be configured as any other appropriate architecture including, but not limited to, long short-term memory (LSTM) networks, Markov networks, BART, generative-adversarial networks (GAN), diffusion models (e.g., Diffusion-LM), and the like.

In one or more embodiments, the online system 140 facilitates a conversation between a user of a client device and a chatbot LLM. Specifically, the online system 140 uses a chatbot LLM to generate responses to the user's messages in the conversation and therefore, when a user interacts with the chatbot LLM through an application of the online system 140, there may be a series of user and chatbot generated messages as the user is proceeding in a conversation with the chatbot LLM. In one or more embodiments, when the chatbot LLM is generating a response, the history of the conversation is used as context information by the chatbot LLM to synthesize the next response. Moreover, when the chatbot LLM is generating a response to a user prompt, the prompt may also include context information that provides additional descriptions or information for a request in the prompt that the chatbot LLM is synthesizing an answer for.

In both cases, the context information may consume a significant amount of memory in the transformer model as the chatbot LLM. As an example, the transformer model may have a plurality of attention blocks each configured with an attention layer. An attention layer is coupled to receive keys, values, and queries to generate attention outputs, and the context information is typically encoded and stored as key and value tokens in these attention layers. Therefore, the longer the context information, the larger number of keys and values are stored for the model until the conversation or request is completed.

Therefore, in one or more embodiments, the methods described herein evaluate various ways of reducing or compressing the context information and evaluating the effectiveness of these reduction methods. This way, the online system 140 can effectively reduce the size of the context information so that the transformer model uses a lesser amount of memory and computational resources. Moreover, while LLM's deployed on large-scale cloud platforms may have capacity to store a significant number of context tokens, small-scale LLM's that are embedded within, for example, a sensor device may have limited amount of memory and computing capacity. The methods described herein may be used to evaluate context information and compression algorithms for compressing context information in these limited execution environments.

In one or more embodiments, responsive to receiving a user message, the online system 140 generates a prompt for input to the chatbot LLM. In addition to a request to infer a response to the user's message, the prompt may include context information which is any amount of information of the conversation, such as the full text of the conversation, the text of the most recent user message, or the compressed text of the conversation that occurred up to the point of generating the next response for the user message. The prompt may also include information external to the conversation, such as user data or order data.

The context information for the conversation may include the conversation's “full context,” including the full text of all messages in the conversation that occurred up to that point in time, as well as information external to the conversation. For example, in response to a user's message, “My grocery order arrived late and is missing pepperoni pizza, ABC Co. coffee makers, and the gallon of shampoo I ordered,” the online system 140 may generate a prompt such as “Given <user's message>, draft a response to the user,” and also include context information of the full user message. The online system 140 provides the prompt to the model serving system 150 for execution by the chatbot LLM. The online system 140 receives a response generated by executing the chatbot LLM on the prompt, for example “I'm sorry that happened. To give compensation, I need additional details. ABC Co. coffee makers require certified delivery, did you sign on delivery?” The online system 140 may log the conversation, including both the user responses and the chatbot LLM responses, in the data store 240.

In one or more embodiments, for the generation of a current response that is the t-th message in a conversation (in response to a user response that is the t−1-th message), including the full prior conversation up to that point in time can be overwhelming on memory requirements and computational processing capabilities of an LLM. Thus, in one instance, the online system 140 may perform one or more compression policies on the prior conversation to compress the conversation into a smaller number of tokens, which are text-related units of processing by the chatbot LLM.

In one or more embodiments, the online system 140 uses an adversarial LLM to generate synthetic user responses with the adversarial objective of causing the chatbot LLM, given either the full or compressed context of the conversation that includes the synthetic user response, to produce a response different than a benchmark LLM response. Further details of generating a synthetic user response are described with respect to the guided conversation module 225 of the online system 140.

The online system 140 evaluates a conversation context compression algorithm using both the chatbot LLM and adversarial LLM. The online system 140 retrieves a logged conversation from the data store 240 and generates a compressed conversation context from the logged conversation. The online system 140 generates a synthetic user response by applying the adversarial LLM and generates a test conversation by replacing a user response in the conversation with the synthetic user response. The online system 140 generates a compressed context of the test conversation. The online system 140 generates a test chatbot LLM response by prompting the chatbot LLM with the compressed context of the test conversation. The online system evaluates the conversation context compression algorithm by comparing the test chatbot response with a benchmark chatbot response.

In another one or more embodiments, the context evaluation module 225 evaluates the relevance of various components of the contextual information to predicting responses or predictions to task requests to a machine-learned model (e.g., LLM) deployed by the model serving system 150. Specifically, an LLM may receive (e.g., in the prompt) a request to infer a task and contextual information for inferring the task and generate a response or prediction for that task as the output. The perplexity of a LLM may indicate a rate of error between an actual, expected output and the output generated by the LLM. In one or more instances, a lower perplexity indicates lower discrepancy or error.

In one or more embodiments, the task for the model serving system 150 is based on knowledge of the online system 140 that is fed to the machine-learned model of the model serving system 150, rather than relying on general knowledge encoded in the model weights of the model. Thus, one objective may be to perform various types of queries on the external data in order to perform any task that the machine-learned model of the model serving system 150 could perform. For example, the task may be to perform question-answering, text summarization, text generation, and the like based on information contained in an external dataset.

Thus, in one or more embodiments, the online system 140 is connected to an interface system 160. The interface system 160 receives external data from the online system 140 and builds a structured index over the external data using, for example, another machine-learned language model or heuristics. The interface system 160 receives one or more queries from the online system 140 on the external data. The interface system 160 constructs one or more prompts for input to the model serving system 150. A prompt may include the query of the user and context obtained from the structured index of the external data. In one instance, the context in the prompt includes portions of the structured indices as contextual information for the query. The interface system 160 obtains one or more responses from the model serving system 160 and synthesizes a response to the query on the external data. While the online system 140 can generate a prompt using the external data as context, often times, the amount of information in the external data exceeds prompt size limitations configured by the machine-learned language model. The interface system 160 can resolve prompt size limitations by generating a structured index of the data and offers data connectors to external data sources.

FIG. 1B illustrates an example system environment for an online system 140, in accordance with one or more embodiments. The system environment illustrated in FIG. 1B includes a customer client device 100, a picker client device 110, a retailer computing system 120, a network 130, and an online system 140. Alternative embodiments may include more, fewer, or different components from those illustrated in FIG. 1B, and the functionality of each component may be divided between the components differently from the description below. Additionally, each component may perform their respective functionalities in response to a request from a human, or automatically without human intervention.

The example system environment in FIG. 1A illustrates an environment where the model serving system 150 and/or the interface system 160 is managed by a separate entity from the online system 140. In one or more embodiments, as illustrated in the example system environment in FIG. 1B, the model serving system 150 and/or the interface system 160 is managed and deployed by the entity managing the online system 140.

FIG. 2 illustrates an example system architecture for an online system 140, in accordance with one or more embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. The data collection module 200 may only collect data describing a user if the user has previously explicitly consented to the online system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery timeframe. The data collection module 200 may collect the customer data from sensors on the customer client device 100 or based on the customer's interactions with the online system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular warehouse), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has services orders for the online system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order. In one or more embodiments, the order data includes user data for users associated with the order, such as customer data for a customer who placed the order or picker data for a picker who serviced the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In one or more embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In one or more embodiments, the item selection model uses item embeddings describing items and customer embeddings describing customers to score items. These item embeddings and customer embeddings may be generated by separate machine learning models and may be stored in the data store 240.

In one or more embodiments, the content presentation module 210 scores items based on a search query received from the customer client device 100. A search query is free text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In one or more embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 that manages orders for items from customers. The order management module 220 receives orders from a customer client device 100 and offers the orders to pickers for service based on picker data. For example, the order management module 220 offers an order to a picker based on the picker's location and the location of the retailer from which the ordered items are to be collected. The order management module 220 may also offer an order to a picker based on how many items are in the order, a vehicle operated by the picker, the delivery location, the picker's preferences on how far to travel to deliver an order, the picker's ratings by customers, or how often a picker agrees to service an order.

In one or more embodiments, the order management module 220 determines when to offer an order to a picker based on a delivery timeframe requested by the customer with the order. The order management module 220 computes an estimated amount of time that it would take for a picker to collect the items for an order and deliver the ordered item to the delivery location for the order. The order management module 220 offers the order to a picker at a time such that, if the picker immediately services the order, the picker is likely to deliver the order at a time within the timeframe. Thus, when the order management module 220 receives an order, the order management module 220 may delay in offering the order to a picker if the timeframe is far enough in the future.

When the order management module 220 offers an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In one or more embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In one or more embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In one or more embodiments, the order management module 220 computes an estimated time of arrival for the picker at the delivery location and provides the estimated time of arrival to the customer.

In one or more embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In one or more embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

### Guided Conversation Context Compression with Adversarial Hypothetical Questions for Compressor Evaluation

The guided conversation module 225 evaluates the performance of a compressor in compressing the context of a conversation between a user and a chatbot LLM. The compressor may use a compression algorithm or may follow a compression policy to compress the context of the conversation. In one instance, the compression policy is a machine-learned model, a text-based heuristic, and the like. For example, the machine-learned model may be a compression LLM that, when given a prompt including a conversation, generates an output that compresses the input conversation to a smaller number of tokens (e.g., corresponding to a smaller number of sub-words, words, characters, etc.) while capturing the key parts and semantic meaning of the conversation. In one or more embodiments, the compression policy reduces the number of key and value tokens in attention layers of the transformer architecture.

A strong compression policy preserves important information of the conversation while reducing the length of the context fed to the chatbot LLM to elicit a response in the conversation that would be consistent if the response was synthesized based on the full conversation context. The guided conversation module 225 evaluates the performance of the compressor on chat conversations logged by the online system 140, where the logged chat conversations include conversations between users of the customer client device 100 and the chatbot LLM, and where the online system 140 generated the prompts for the chatbot LLM responses based on the full context of the conversation.

The guided conversation module 225 selects a logged chat conversation on which to evaluate the compressor and retrieves a chatbot LLM response from the logged chat conversation. As the online system 140 generated the chatbot LLM response based on the full context of the conversation, the chatbot LLM response may be referred to herein as the “benchmark” chatbot LLM response, namely, the response generated by executing the chatbot LLM on a prompt with the uncompressed version of the prior conversation. For example, the uncompressed version of the prior conversation may correspond to the greatest possible amount of contextual information about the conversation.

The guided conversation module 225 may generate a compressed conversation context by applying the compression algorithm to the full context of a conversation. The compressed conversation context may express the information of the full conversation context more compactly, for example with fewer overall characters or excluding information determined by the compression algorithm to be less important. For example, the guided conversation module 225 may apply the compression algorithm to a first user response “My grocery order arrived late and is missing pepperoni pizza, ABC Co. coffee makers, and the gallon of shampoo I ordered,” producing the compressed conversation context, “missing items: pizza, shampoo, coffee maker” into a fewer number of tokens. In one or more embodiments, the guided conversation module 225 may apply the compression algorithm to the conversation used to generate the benchmark chatbot LLM response, and compare the response of the chatbot application given the compressed context with the benchmark chatbot LLM response. If the responses match semantically, this may be an indication that the compressor is robust on the conversation used to generate the benchmark response.

In one or more embodiments, the guided conversation module 225 generates a synthetic user response to replace a user response in the conversation. Specifically, the guided conversation module 225 uses the adversarial LLM to generate the synthetic user response with an adversarial objective of causing the chatbot LLM, given a conversation that includes the substituted synthetic user response, to produce a lower-quality response than the benchmark LLM response.

The guided conversation module 225 generates a prompt to input into the adversarial LLM. The prompt specifies the user response to be substituted, the benchmark chatbot LLM response, the full conversation context, and/or the compressed conversation context. For example, the guided conversation module 225 may generate the prompt:

“Given a customer support conversation <full context>, this summary of the conversation <compressed context> and the user response <user response to be substituted>, create a variant of the user response that is difficult to summarize or that requires information not in the summary of the conversation to answer, and that causes violations of chatbot objectives <chatbot proxy evaluation description>. Do not say anything incompatible with the user response and include all information in the user response. You may add irrelevant but plausible details.”

The guided conversation module 225 provides the prompt to the model serving system 150 for execution by the adversarial LLM and receives a synthetic user request generated by executing the adversarial LLM on the prompt. For example, for the user response “Yes, I signed on delivery, but I didn't look closely at the package because my neighbor was mowing the lawn and it was very loud and also my smoke alarm was going off,” the guided conversation module 225 may use the adversarial LLM to generate the synthetic user response “Yes, but I was rushed because of late delivery, can I still get compensation for all the missing items?” Note that while the example synthetic user response retains most of the context of the user response, it does not explicitly mention the important context information that the user “signed on delivery” but implies the user did because of the “Yes” at the start of the synthetic user response.

The guided conversation module 225 generates a test conversation by replacing the user response with the synthetic user response. The guided conversation module 225 may generate a compressed context of the test conversation using the compression algorithm.

The guided conversation module 225 generates a test chatbot LLM response to compare the response to the benchmark chatbot LLM response. The guided conversation module 225 generates a prompt for input into the chatbot LLM. The prompt specifies the compressed conversation context of the test conversation. For example, the guided conversation module 225 may generate the prompt,

“Given <compressed test conversation context>, draft a response to the user.”
The guided conversation module 225 provides the prompt to the model serving system 150 for execution by the chatbot LLM and receives the test chatbot response generated by executing the chatbot LLM on the prompt.

The guided conversation module 225 evaluates the compressor performance by comparing the test chatbot response with the benchmark chatbot response. For each response, both the test response and the benchmark response, the guided conversation module 225 may score the response based on product-specific metrics or proxy metrics or heuristics around the chatbot's brand-safety, helpful tone, legal compliance, and time taken to close a conversation. The guided conversation module 225 may compare the scores of the test and the benchmark, with closer scores indicating that the responses are similar in quality and that the compressor performed well, with farther scores indicating that the responses are dissimilar in quality and that the compressor performed poorly. As an example, in the example described above, whether the response indicated that coffee makers should be signed on delivery may be an important factor in determining the score with respect to product-specific metrics.

In one or more embodiments, the guided conversation module 225 may change the compression algorithm or adversarial LLM prompt responsive to the score for the test chatbot LLM response being within or outside of a threshold difference from the score of the benchmark chatbot LLM response. For example, responsive to the scores being within a threshold of difference, the guided conversation module 225 may change the compression algorithm to compress more or less, and/or change the adversarial LLM prompt such that the adversarial LLM provides a synthetic user response that provides less context or is further from the real user response.

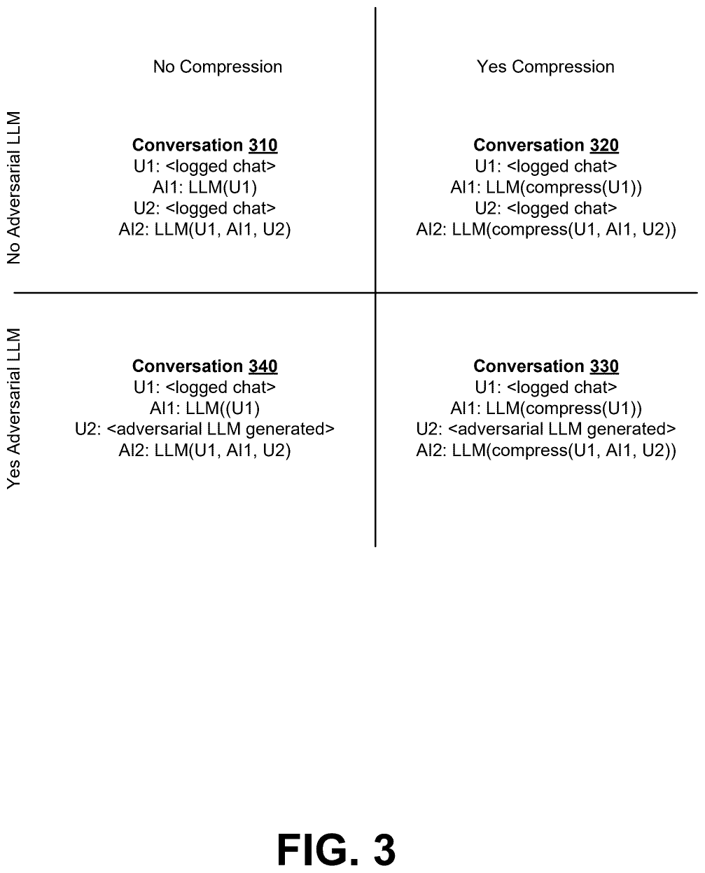

FIG. 3 depicts different strategies for conversational context compression, in accordance with one or more embodiments. In one or more embodiments, the conversations shown in FIG. 3 may be example conversations synthesized by the guided conversation module 225. Conversation 310 is an example conversation where the guided conversation module 225 prompts the chatbot LLM with the full context of the conversation. Namely, the response AI1 is an LLM generated response prompted with the user's first response, U1, such that AI1: LLM (U1). For example, U1 may be “My grocery order arrived late and is missing pepperoni pizza, ABC Co. coffee makers, and the gallon of shampoo I ordered.” (117 characters). The chatbot LLM may receive the entire text of the user's message (117 characters) and generate a response message, “I'm sorry that happened. To give compensation, I need additional details. ABC Co. coffee makers require certified delivery, did you sign on delivery?” (147 characters).

For the chatbot's second response AI2, the guided conversation module prompts the chatbot LLM with the full context of the conversation, including the user's first response U1, the chatbot LLM's first response AI1, and the user's second response, U2, so that AI2: LLM (U1, AI1, U2). For example, U2 may be “Yes, I signed on delivery, but I didn't look closely at the package because my neighbor was mowing the lawn and it was very loud and also my smoke alarm was going off.” (167 characters). The guided conversation module 225 may prompt the chatbot LLM with the entire text of U2 (167 characters), the entire text of AI1 (147 characters), and the entire text of U1 (177 characters), a total of 491 characters of text. Based on the full context of the conversation 310, the chatbot LLM may generate AI2 response, “Thank you, we will issue pizza and shampoo refunds and follow up with the shopper on the certified coffee maker delivery.”

Conversation 320 is an example conversation where the guided conversation module 225 prompts the chatbot LLM with the compressed context of the conversation. The response AI1 is an LLM generated response prompted with the compressed user response compress (U1) such that AI1: LLM (compress (U1)). For example, for the same U1 response from conversation 310, “My grocery order arrived late and is missing pepperoni pizza, ABC Co. coffee makers, and the gallon of shampoo I ordered.” (117 characters), the compressed context may be “missing items: pizza, shampoo, coffee maker” (39 characters). The guided conversation module 225 may generate AI1 with the compressed context (39 characters) as “I'm sorry that happened. To give compensation I need additional details. Coffee makers require certified delivery, did you sign on delivery?” (137 characters). Note that the compression algorithm excluded that the coffee makers were from ABC Co. in the compressed context, thus the All response excludes that the coffee makers were from ABC Co. as well.

For the chatbot's second response AI2, the guided conversation module prompts the chatbot LLM with the compressed context of the conversation such that AI2:LLM (compress (U1, AI1, U2)). For example, U2 may be the same as U2 from conversation 310, “Yes, I signed on delivery, but I didn't look closely at the package because my neighbor was mowing the lawn and it was very loud and also my smoke alarm was going off.” (167 characters). The guided conversation module 225 may prompt the chatbot AI with the compressed conversation context “missing items: pizza, shampoo, coffee maker; signature on delivery for coffee maker” (75 characters), generating AI2 as “Thank you, we will issue pizza and shampoo refunds. Because the coffee maker was certified delivery we will contact the shopper for further action.” Note that even with less characters of context than in conversation 310 (75 characters vs. 491 characters) as context, AI2 in conversation 320 is similar to AI2 in conversation 310, indicating that the compression algorithm is robust.

Conversation 330 is an example conversation where the guided conversation module 225 prompts the chatbot LLM with the compressed context of a conversation where U2 has been replaced with a synthetic user response generated by the adversarial LLM (e.g., a test conversation). For example, based on the same U1 from conversations 310 and 320, “My grocery order arrived late and is missing pepperoni pizza, ABC Co. coffee makers, and the gallon of shampoo I ordered.” (117 characters) and AI1 generated with compressed context like in conversation 310, “I'm sorry that happened. To give compensation I need additional details. Coffee makers require certified delivery, did you sign on delivery?” (137 characters), the guided conversation module 225 generates a prompt for the adversarial LLM. The adversarial LLM may output a synthetic user response, “Yes, but I was rushed because of late delivery, can I still get compensation for all the missing items?” (103 characters) which the guided conversation module 225 substitutes in for U2. Note that the synthetic user response answers the question posed by AI1, but excludes the words “signed on delivery,” and therefore, uses missing information to generate the synthetic user response.

For the chatbot's second response AI2, the guided conversation module 225 prompts the chatbot LLM with the compressed context of U2, “missing items: pizza, shampoo, coffee maker; late delivery.” (55 characters). As U2 does not include “signed on delivery,” the compressed context also fails to include that the user signed the package on delivery. The guided conversation module 225 generates AI2 using the compressed context that excludes “signed on delivery,” producing “Thank you, we will issue pizza and shampoo refunds and coffee maker refunds.” The guided conversation module 225 may compare AI2 of conversation 330 with AI2 of conversation 310 to evaluate the quality of the compressor. In this example, while AI2 of conversation 310 contacts the shopper for further action, AI2 of conversation 330 performs a different action of refunding the user for the shampoo. Therefore, as the synthetic user response still implies that the user had signed on delivery, but the second response AI2 generated a different answer from the benchmark response, this may indicate that the compression algorithm can be further improved.

Conversation 340 is like example conversation 330 in that the guided conversation module 225 replaces U2 with a synthetic user response, but is different from example conversation 330 in that the guided conversation module 225 prompts the chatbot LLM with the full context of the test conversation rather than the compressed context. For example, for the same U1 of conversations 310, 320, and 330 (117 characters), the same AI1 as conversation 310 (147 characters), and the same synthetic user response U2 as conversation 330 (103 characters), the guided conversation module 225 generates a prompt for the chatbot LLM (with a total of 367 characters of context), which outputs AI2, “Thank you, we will issue pizza and shampoo refunds and follow up with the shopper on the certified coffee maker delivery.”

In one or more embodiments, the guided conversation module 225 may generate the second chatbot response AI2 for conversation 340 to ensure that the adversarial LLM has not gone too far in producing a synthetic user response with the goal of making the chatbot LLM response lower in quality. Namely, if AI2 is unable to provide a response of reasonable quality given the full context of a conversation, as is the case in conversation 340, the guided conversation module 225 may adjust the prompt of the adversarial LLM such that the output user synthetic response is closer to the original user response or such that AI2 is similar to AI2 from conversation 310. In the described example, both AI2 of conversation 310 and AI2 of conversation 340 take similar actions of following up with the shopper on delivery of the coffee maker and therefore, the guided conversation module 225 may determine that the adversarial LLM has not generated an unreasonable synthetic user response U2.

The following shows an additional example of conversation 310 in which the guided conversation module 225 prompts the chatbot LLM with the full context of the conversation:
U1: <Autogenerated profile—Gluten Free, likes sweets, likes organic food>
AI1 (context: Full U1 message, 100 chars): I'm your meal planning assistant how can I assist you today?
U2: Please provide a gluten free cookie recipe.
AI2 (context: Full U1, AI1, and U2 messages, 200 chars): Here is a gluten-free chocolate chip cookie recipe <recipe>

This example shows that with the full context of the conversation, AI2 is able to provide the user with a recipe that matches their request in U2 and their profile in U1.

The following shows an additional example of conversation 320, in which the guided conversation module 225 prompts the chatbot LLM with the compressed context of the conversation:
U1: <Autogenerated profile—Gluten Free, likes sweets, likes organic food>
AI1 (compressed context: “User like sweets and organic food”, 40 chars): I'm your meal planning assistant how can I assist you today?
U2: Please provide a gluten free cookie recipe.
AI2 (compressed context: “User likes sweets and organic food. Requests gluten free cookie recipe”, 80 chars): Here is a gluten-free chocolate chip cookie recipe <recipe>

Note that in the above example, the AI2 response of conversation 320 is the same as the AI2 response of conversation 310, despite the compressed context of U1 excluding the fact that the user is gluten free. The user's redundant request for gluten-free cookies in U2 prevented an error, as the compressed context of U2 included “requests gluten free cookie recipe.”

The following shows an additional example of conversation 330, in which the guided conversation module 225 prompts the chatbot LLM with the compressed context of a conversation where U2 has been replaced with a synthetic user response generated by the adversarial LLM (e.g., a test conversation):
U1: <Autogenerated profile—Gluten Free, likes sweets, likes organic food>
AI1 (compressed context: “User likes sweets and organic food”, 40 chars): I'm your meal planning assistant how can I assist you today?
U2 (adversarial LLM generated): Please provide a cookie recipe.
AI2 (compressed context: “User likes sweets and organic food. Requests cookie recipe”, 80 chars): Here is a chocolate chip cookie recipe <recipe that includes gluten ingredients>

Note that in the above example, the response AI2 violated the dietary restrictions of the user, as it failed to provide the user with a gluten-free recipe due to “gluten-free” not being captured in the compression of U1 or U2.

The following shows an additional example of conversation 340, in which conversation 340 is like example conversation 330 in that the guided conversation module 225 replaces U2 with a synthetic user response, but is different from example conversation 330 in that the guided conversation module 225 prompts the chatbot LLM with the full context of the conversation rather than the compressed context:
U1: <Autogenerated profile—Gluten Free, likes sweets, likes organic food>
AI1 (context: Full U1 message, 100 chars): I'm your meal planning assistant how can I assist you today?
U2 (adversarial LLM generated): Please provide a cookie recipe.
AI2 (context: Full U1, AI1, and Adversarial-U2 messages, 190 chars): Here is a gluten-free chocolate chip cookie recipe <recipe>

Note that in the above example, the response AI2 in conversation 340 is the same as the response AI2 in the conversation 310. Because the chatbot LLM was supplied with the full context, it captured that the user is gluten-free and provided a diet-compliant recipe. Therefore, the guided conversation module 225 may determine that the compression algorithm is not capturing the most important contextual information in these example conversations, and may update the compression algorithm for improvement.

### Evaluating Relevance of Contextual Information in a Prompt Using Perplexity Measurements for LLMs

Returning to FIG. 2, the context evaluation module 228 evaluates the relevance of different contextual components in the context with respect to generating responses to requests to a machine-learned model (e.g., LLM) deployed by the model serving system 150. Specifically, an LLM may receive (e.g., in the prompt) a request to infer a task and contextual information for inferring the task and generate a response or prediction for that task as the output.

As described above, often times, the online system 140 includes a significant amount of contextual information in the prompt with the goal of providing the LLM with the maximum amount of information for obtaining a high accuracy response or prediction. However, as LLMs or other transformer-based generation models are memory-bound, this can result in consuming a significant number of tokens being consumed and therefore, result in a significant amount of memory and processing power for LLM execution. Moreover, certain components of the contextual information may be less relevant to obtaining a high-quality response (e.g., because the information is not related to the request).

In one or more embodiments, the context evaluation module 228 performs an evaluation analysis for LLM request types to determine the relevance of contextual components. In one or more embodiments, the evaluation analysis is performed with respect to perplexity metrics. However, it is appreciated other types of performance metrics may be used. The perplexity of a LLM may indicate a rate of error between an actual, expected output and the output generated by the LLM. In one instance, a lower perplexity indicates lower discrepancy or error.

As an example, when a user is presented with a set of items in response to a user query, the LLM may generate a prediction of which items the user will select or purchase, the contextual information may include various user characteristics in addition to the user query and the set of items. As another example, a user may communicate with a customer service application of the online system 140 to respond to an inquiry or prompt generated by the customer service application. During such communications an LLM deployed by the model serving system 150 may generate a prediction of how the user will respond to the prompt or inquiry. The contextual information may include logs of the session for which an error occurred for the user (i.e., subject of the chatbot conversation) and the entire prior conversation. As yet another example, a user may communicate with a customer service application and the LLM may generate a prediction on whether the communication is from a user attempting to perform fraud; the contextual information may include various attributes, such as the device identifier (ID) of the user, network ID, MAC address of the device, how long the user took to respond, and the like.

To inform these predictions, the context evaluation module 228 stores user characteristic data to provide additional context to user actions within the online system 140. In other words, contextual components are additional information regarding user characteristics or the request that can be injected into a request to the LLM. One example of contextual components, as described above, are user characteristics. For example, user characteristics may describe how long a user has used the online system 140 or the number of purchases made by the user through the online system 140. Additional examples of contextual information include, but are not limited to, whether the device ID corresponds to the device normally used by the user, whether the user is accessing the online system 140 through a website or mobile application, the user's past customer support history, the user's duration as a customer, and the level of subscription associated with the user.

Some contextual components may be more relevant to predicting user responses to certain queries than other contextual components. For example, a user's dietary preferences may be more relevant to predicting which items a user will select compared to the user's customer support history. However, the user's customer support history may be more relevant to predicting the user's response to a customer service prompt than their dietary preferences. Accordingly, the context evaluation module 228 determines a relevance of each contextual component to generating a prediction in response to a given query for a user and identifies the most relevant contextual components for that prediction.

To determine the relevance of individual contextual components or a subset of contextual components, the context evaluation module 228 constructs a prompt and a task request to the LLM to predict the response of a given user to the prompt. The context evaluation module 228 constructs a prompt describing the task request and a subset of one or more contextual components surrounding the task request. In one or more embodiments, the task request is to predict a user's response to a message received from the online system 140. In another embodiment, the task request is to predict a user's activity in response to a presentation of options (e.g., selection of certain presented items to be added to the cart). The context evaluation module 228 transmits the prompt to the LLM, which determines the relevance of each contextual component to the relevance. In one or more embodiments, the LLM characterizes the relevance of each contextual component as a perplexity measurement.

This process is repeated for different subsets of contextual components, and the relevance of each respective subset of contextual components are evaluated based on the computed perplexity scores. In one or more embodiments, the relevance of different types of contextual components may be recorded in association with the topic of the request or conversation that is being processed by the LLM. This way, when a new request or conversation is being processed, the context evaluation module 228 may select contextual components that were identified to have high relevance to the topic of the request or conversation and inject only those contextual components, saving memory and computational resources for the LLM.

In one instance, when the task is to predict a response in a given communication history, the context evaluation module 228 receives a transcript of a user conversation with a chatbot application and selects a subset of textual information. The context evaluation module 228 modifies the subset of textual information by incorporating a selected subset of contextual components. The LLM generates a prediction of the user's response based on the modified input. Because the subset of text was selected from a historical conversation sent by the user, the actual text of the historical message represents a ground truth for the LLM's prediction. The LLM compares its prediction to the user's actual response and determines a perplexity score for the prediction. As described herein, a perplexity score determined for a prediction characterizes a level of difference between the user's response and the LLM's predicted response.

As an example, the LLM's predicted user response may be a message communicated via an interface. As an example, the context evaluation module 228 may select a message where the user responded, “I ordered milk and received 1% milk, but I requested 2% milk.” The context evaluation module 228 may select the subset of textual information as the phrase “I ordered milk and received 1% milk.” The context evaluation module 228 may modify the subset of textual information with a first contextual component that indicates the dietary restrictions of the user, and predict that the user's message would continue with “but I am lactose intolerant.”

Subsequently, the context evaluation module 228 modifies the subset of textual information with a second set of contextual components that indicates the order history of the user, and predicts that the user's message would continue with “but I requested 2% milk.” For each prediction and the corresponding set of contextual components, the context evaluation module 228 computes a perplexity score by comparing the predicted text to the user's actual message. Given the accuracy of the prediction based on the second set of contextual components, the LLM may determine a lower perplexity score (i.e., higher accuracy) for the prediction based on the second set of contextual components relative to the prediction based on the first set of contextual components.

As described above, in one instance, the task is to predict a selection by a user within the online system 140. For example, the LLM may select a user action where they were presented with four brands of cereal—Brand A, Brand B, Brand C, and Brand D—and they selected Brands A and B for checkout. The context evaluation module 228 may modify the input with a first set of contextual components (e.g., geographical location of the user) and predict that the user would select only Brand C. The context evaluation module 228 may modify the input with a second set of contextual components (e.g., order history of the user) and predict that the user would select only Brand A. The context evaluation module 228 may modify the input with a third set of contextual components (e.g., dietary restrictions of the user) and predict that the user would select brands A and B. Given the accuracy of the prediction based on the third set of contextual components, the context evaluation module 228 may determine a lowest perplexity score for the prediction based on third set of contextual components. Moreover, between the other two predictions, the context evaluation module 228 may determine a lower perplexity score for the prediction based on the second set of contextual components than the first set of contextual components.

The context evaluation module 228 receives the perplexity scores and maps each perplexity score to the contextual component(s) used to make the corresponding prediction. Because the perplexity score characterizes the accuracy of the prediction relative to the user's actual response, the context evaluation module 228 interprets each perplexity score as a measure of how relevant the corresponding contextual inputs are to the task request. In some embodiments, the context evaluation module 228 compares the perplexity score for each contextual component to a threshold perplexity. The context evaluation module 228 identifies any contextual component corresponding to a perplexity score below the threshold perplexity as relevant to predicting the user's response. The context evaluation module 228 labels the prediction based on the context surrounding the user's response and maps the relevant contextual components to the label such that the context evaluation module 228 may identify the relevant contextual components in a future prediction given the same or a related context. For example, based on the analysis, the context evaluation module 228 may select the top 20 relevant contextual components for processing a particular request type.

Additionally or alternatively, the context evaluation module 228 may perform a contextual bandit analysis, where each bandit corresponds to a combination of contextual components to include in the prompt. For example, based on the results of the evaluation, the context evaluation module 228 may identify that a first set of contextual components [1, 3, 10] and a second set of contextual components [2, 3, 9] had the highest relevance with respect to perplexity. The context evaluation module 228 may deploy each set as a separate bandit to determine which combinations work best with different personas or users identified by the online system 140.

The machine learning training module 230 trains machine learning models used by the online system 140. For example, the machine learning module 230 may train the item selection model, the availability model, or any of the machine-learned models deployed by the model serving system 150. The online system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross entropy loss function. The machine learning training module 230 updates the set of parameters for the machine learning model based on the score generated by the loss function. For example, the machine learning training module 230 may apply gradient descent to update the set of parameters.

The data store 240 stores data used by the online system 140. For example, the data store 240 stores customer data, item data, order data, and picker data for use by the online system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

With respect to the machine-learned models hosted by the model serving system 150, the machine-learned models may already be trained by a separate entity from the entity responsible for the online system 140. In another embodiment, when the model serving system 150 is included in the online system 140, the machine-learning training module 230 may further train parameters of the machine-learned model based on data specific to the online system 140 stored in the data store 240. As an example, the machine-learning training module 230 may obtain a pre-trained transformer language model and further fine tune the parameters of the transformer model using training data stored in the data store 240. The machine-learning training module 230 may provide the model to the model serving system 150 for deployment.

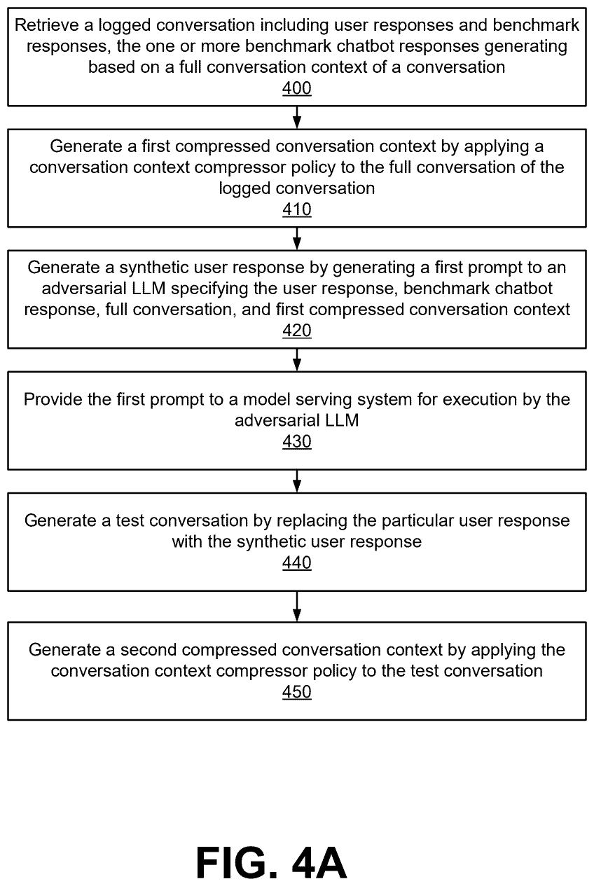

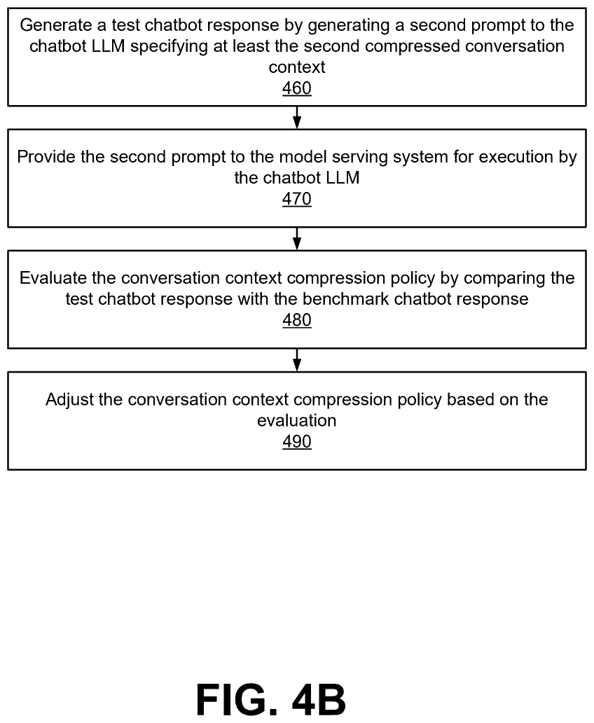

FIGS. 4A-4B is a flowchart for a method of evaluating compression policies for a chatbot application, in accordance with one or more embodiments. Alternative embodiments may include more, fewer, or different steps from those illustrated in FIGS. 4A-4B, and the steps may be performed in a different order from that illustrated in FIGS. 4A-4B. The steps may be performed by an online concierge system (e.g., online system 140). Additionally, each of these steps may be performed automatically by the online system without human intervention.

The online system retrieves 400 a logged conversation. The logged conversation may include one or more user responses and one or more benchmark chatbot responses, and the one or more benchmark chatbot responses generated using a chatbot large learning model (LLM) and based on a full conversation context of a conversation that occurred prior to the benchmark chatbot responses. The online system 140 generates 410 a first compressed conversation context by applying a conversation context compressor policy to the full conversation context of the logged conversation.

The online system 140 generates 420 a synthetic user response by generating a first prompt for input to an adversarial LLM. In one or more embodiments, the first prompt may specify at least a particular user response of the one or more user responses, a particular benchmark chatbot response of the one or more benchmark chatbot responses that is a response to the particular user response, the full conversation context, and the first compressed conversation context. The online system 140 provides 430 the first prompt to a model serving system 150 for execution by the adversarial LLM. The online system 140 receives, from the model serving system, a synthetic user request generated by executing the adversarial LLM on the first prompt.

The online system 140 generates 440 a test conversation by replacing the particular user response with the synthetic user response. The online system 140 generates 450 a second compressed conversation context by applying the conversation context compressor policy to the test conversation. The online system 140 generates 460 a test chatbot response by generating a second prompt for input to the chatbot LLM. In one or more embodiments, the second prompt specifies at least the second compressed conversation context. The online system 140 provides 470 the second prompt to the model serving system for execution by the chatbot LLM. The online system 140 receives, from the model serving system, the test chatbot response generated by executing the chatbot LLM on the second prompt.

The online system 140 evaluates 480 the conversation context compression policy by comparing the test chatbot response with the benchmark chatbot response. The online system 140 adjusts 490 the conversation context compression policy based on the evaluation.

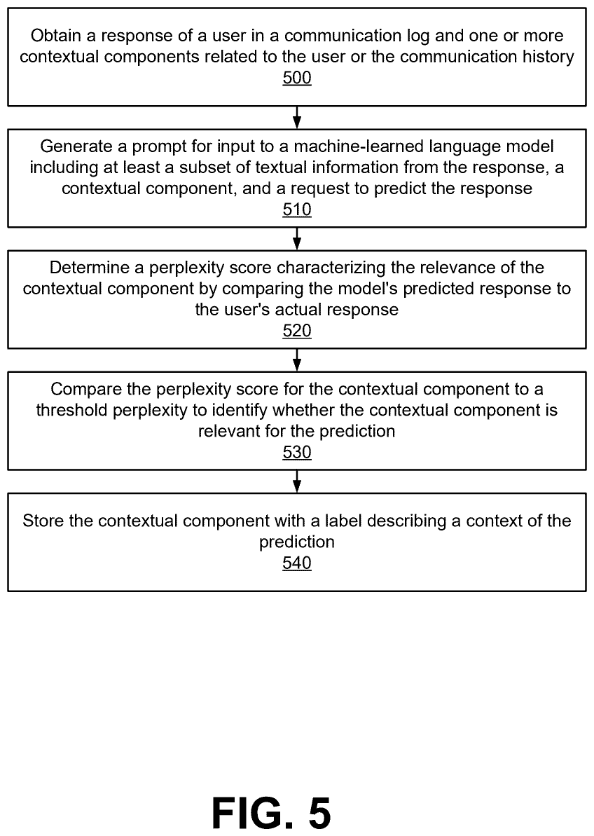

FIG. 5 is a flowchart for a method of determining the relevance of contextual components for a LLM, in accordance with some embodiments. Alternative embodiments may include more, fewer, or different steps from those illustrated in FIG. 5, and the steps may be performed in a different order from that illustrated in FIG. 5. These steps may be performed by an online concierge system (e.g., online system 140). Additionally, each of these steps may be performed automatically by the online system without human intervention.

The online system 140 obtains 500 a response of the user in a communication log of the user with a chatbot application, one or more contextual components related to the user and/or the communication history. The online system 140 generates 510 a prompt for input to a machine-learned language model. The prompt may include at least a subset of textual information from the response, a contextual component, and a request to predict the response given the subset of textual information and contextual component. The online system 140 determines 520 a perplexity score characterizing the relevance of the contextual component by comparing the model's predicted response to the user's actual response. The online system 140 compares 530 the perplexity score for the contextual component to a threshold perplexity to identify whether the contextual component is relevant to predicting the user's response. The online system 140 stores 540 the contextual component with a label describing a context of the prediction.

In one or more embodiments, the different sets of contextual components stored in conjunction with different topics of requests or conversations may be used when serving a response to a new request or conversation. For example, to formulate a response for a given request related to orders, the relevant contextual components stored for these types of requests may be the user's order history. The online system 140 obtains the order history for the user of the new request and may use this information as the context when prompting the LLM to generate a response, without other contextual components that were deemed not to significantly affect the perplexity of the outputs.

### Additional Considerations

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In one or more embodiments, a software module is implemented with a computer program product comprising one or more computer-readable media storing computer program code or instructions, which can be executed by a computer processor for performing any or all of the steps, operations, or processes described. In one or more embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one ossr more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or”. For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, comprising:
retrieving a logged conversation, the logged conversation including one or more user responses and one or more benchmark chatbot responses, the one or more benchmark chatbot responses generated using a chatbot large learning model (LLM) and based on a full conversation context of a conversation that occurred prior to the benchmark chatbot responses;
generating a first compressed conversation context by applying a conversation context compressor policy to the full conversation context of the logged conversation;
generating a synthetic user response by:
generating a first prompt for input to an adversarial LLM, the first prompt specifying at least a particular user response of the one or more user responses, a particular benchmark chatbot response of the one or more benchmark chatbot responses that is a response to the particular user response, the full conversation context, and the first compressed conversation context;
providing the first prompt to a model serving system for execution by the adversarial LLM; and
receiving, from the model serving system, a synthetic user request generated by executing the adversarial LLM on the first prompt;
generating a test conversation by replacing the particular user response with the synthetic user response;
generating a second compressed conversation context by applying the conversation context compressor policy to the test conversation;
generating a test chatbot response by:
generating a second prompt for input to the chatbot LLM, the second prompt specifying at least the second compressed conversation context;
providing the second prompt to the model serving system for execution by the chatbot LLM; and
receiving, from the model serving system, the test chatbot response generated by executing the chatbot LLM on the second prompt;
evaluating the conversation context compression policy by comparing the test chatbot response with the benchmark chatbot response; and
adjusting the conversation context compression policy based on the evaluation.

2. The method of claim 1, wherein the chatbot LLM is configured as a transformer architecture including one or more attention layers, an attention layer coupled to receive one or more queries, one or more keys, and one or more values and generate a set of attention outputs.

3. The method of claim 2, wherein a number of tokens for the second compressed conversation context is smaller than a number of tokens for the test conversation.

4. The method of claim 1, further comprising:
generating a chatbot response by:
generating a third prompt for input to the chatbot LLM, the third prompt specifying at least the first compressed conversation context;
providing the third prompt to the model serving system for execution by the chatbot LLM; and
receiving, from the model serving system, the chatbot response generated by executing the chatbot LLM on the third prompt; and
evaluating the conversation context compression policy by comparing the chatbot response with the benchmark chatbot response.

5. The method of claim 1, further comprising:
obtaining a score for the benchmark chatbot response with respect to one or a combination of a set of factors including response accuracy, item-specific metrics, proxy metrics, and tone; and
obtaining a second score for the test chatbot response with respect to one or a combination of the set of factors.

6. The method of claim 5, wherein evaluating the conversation context compression policy comprises:
comparing the score for the benchmark chatbot response with the second score for the test chatbot response with the benchmark chatbot response; and
identifying whether a difference between the score and the second score is above a threshold; and
responsive to the determination being above the threshold, adjusting the conversation context compression policy.

7. The method of claim 1, wherein the synthetic user response omits at least a portion of information from the particular user response.

8. A non-transitory computer-readable storage medium storing instructions that, when executed by a computer processor system, cause the computer processor system to perform operations comprising:
retrieving a logged conversation, the logged conversation including one or more user responses and one or more benchmark chatbot responses, the one or more benchmark chatbot responses generated using a chatbot large learning model (LLM) and based on a full conversation context of a conversation that occurred prior to the benchmark chatbot responses;
generating a first compressed conversation context by applying a conversation context compressor policy to the full conversation context of the logged conversation;
generating a synthetic user response by:
generating a first prompt for input to an adversarial LLM, the first prompt specifying at least a particular user response of the one or more user responses, a particular benchmark chatbot response of the one or more benchmark chatbot responses that is a response to the particular user response, the full conversation context, and the first compressed conversation context;
providing the first prompt to a model serving system for execution by the adversarial LLM; and
receiving, from the model serving system, a synthetic user request generated by executing the adversarial LLM on the first prompt;
generating a test conversation by replacing the particular user response with the synthetic user response;
generating a second compressed conversation context by applying the conversation context compressor policy to the test conversation;
generating a test chatbot response by:
generating a second prompt for input to the chatbot LLM, the second prompt specifying at least the second compressed conversation context;
providing the second prompt to the model serving system for execution by the chatbot LLM; and
receiving, from the model serving system, the test chatbot response generated by executing the chatbot LLM on the second prompt;
evaluating the conversation context compression policy by comparing the test chatbot response with the benchmark chatbot response; and
adjusting the conversation context compression policy based on the evaluation.

9. The non-transitory computer-readable storage medium of claim 8, wherein the chatbot LLM is configured as a transformer architecture including one or more attention layers, an attention layer coupled to receive one or more queries, one or more keys, and one or more values and generate a set of attention outputs.

10. The non-transitory computer-readable storage medium of claim 9, wherein a number of tokens for the second compressed conversation context is smaller than a number of tokens for the test conversation.

11. The non-transitory computer-readable storage medium of claim 8, the operations further comprising:
generating a chatbot response by:
generating a third prompt for input to the chatbot LLM, the third prompt specifying at least the first compressed conversation context;
providing the third prompt to the model serving system for execution by the chatbot LLM; and
receiving, from the model serving system, the chatbot response generated by executing the chatbot LLM on the third prompt; and
evaluating the conversation context compression policy by comparing the chatbot response with the benchmark chatbot response.

12. The non-transitory computer-readable storage medium of claim 8, the operations further comprising:
obtaining a score for the benchmark chatbot response with respect to one or a combination of a set of factors including response accuracy, item-specific metrics, proxy metrics, and tone; and
obtaining a second score for the test chatbot response with respect to one or a combination of the set of factors.

13. The non-transitory computer-readable storage medium of claim 12, wherein operations for evaluating the conversation context compression policy comprises:
comparing the score for the benchmark chatbot response with the second score for the test chatbot response with the benchmark chatbot response; and
identifying whether a difference between the score and the second score is above a threshold; and
responsive to the determination being above the threshold, adjusting the conversation context compression policy.

14. The non-transitory computer-readable storage medium of claim 8, wherein the synthetic user response omits at least a portion of information from the particular user response.

15. A computer system comprising:
a computer processor system; and
a non-transitory computer-readable storage medium storing instructions that, when executed by the computer processor system, cause the computer processor system to perform operations comprising:
retrieving a logged conversation, the logged conversation including one or more user responses and one or more benchmark chatbot responses, the one or more benchmark chatbot responses generated using a chatbot large learning model (LLM) and based on a full conversation context of a conversation that occurred prior to the benchmark chatbot responses;
generating a first compressed conversation context by applying a conversation context compressor policy to the full conversation context of the logged conversation;
generating a synthetic user response by:
generating a first prompt for input to an adversarial LLM, the first prompt specifying at least a particular user response of the one or more user responses, a particular benchmark chatbot response of the one or more benchmark chatbot responses that is a response to the particular user response, the full conversation context, and the first compressed conversation context;
providing the first prompt to a model serving system for execution by the adversarial LLM; and
receiving, from the model serving system, a synthetic user request generated by executing the adversarial LLM on the first prompt;
generating a test conversation by replacing the particular user response with the synthetic user response;
generating a second compressed conversation context by applying the conversation context compressor policy to the test conversation;
generating a test chatbot response by:
generating a second prompt for input to the chatbot LLM, the second prompt specifying at least the second compressed conversation context;
providing the second prompt to the model serving system for execution by the chatbot LLM; and
receiving, from the model serving system, the test chatbot response generated by executing the chatbot LLM on the second prompt;
evaluating the conversation context compression policy by comparing the test chatbot response with the benchmark chatbot response; and
adjusting the conversation context compression policy based on the evaluation.

16. The computer system of claim 15, wherein the chatbot LLM is configured as a transformer architecture including one or more attention layers, an attention layer coupled to receive one or more queries, one or more keys, and one or more values and generate a set of attention outputs.

17. The computer system of claim 16, wherein a number of tokens for the second compressed conversation context is smaller than a number of tokens for the test conversation.

18. The computer system of claim 15, the operations further comprising:
generating a chatbot response by:
generating a third prompt for input to the chatbot LLM, the third prompt specifying at least the first compressed conversation context;
providing the third prompt to the model serving system for execution by the chatbot LLM; and
receiving, from the model serving system, the chatbot response generated by executing the chatbot LLM on the third prompt; and
evaluating the conversation context compression policy by comparing the chatbot response with the benchmark chatbot response.

19. The computer system of claim 15, the operations further comprising:
obtaining a score for the benchmark chatbot response with respect to one or a combination of a set of factors including response accuracy, item-specific metrics, proxy metrics, and tone; and
obtaining a second score for the test chatbot response with respect to one or a combination of the set of factors.

20. The computer system of claim 19, wherein operations for evaluating the conversation context compression policy comprises:
comparing the score for the benchmark chatbot response with the second score for the test chatbot response with the benchmark chatbot response; and
identifying whether a difference between the score and the second score is above a threshold; and
responsive to the determination being above the threshold, adjusting the conversation context compression policy.
